(19) United States
(12) Patent Application Publication
(10) Pub. No.: US 2009/0005514 A1
(43) Pub. Date: Jan. 1, 2009

(54) TOUGHENED POLYESTER AND ARTICLES THEREFROM

(75) Inventors: Julius Uradnisheck, Glen Mills, PA (US); David J. Walsh, Chadds Ford, PA (US); Mark B. Kelly, Beaumont, TX (US); Frank Aerden, Oosthan (BE)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. du Pont de Nemours and Company, Wilmington, DE (US)

(21) Appl. No.: 12/145,318

(22) Filed: Jun. 24, 2008

Related U.S. Application Data
(60) Provisional application No. 60/947,172, filed on Jun. 29, 2007.

(51) Int. Cl. C08F 120/10

(52) U.S. Cl. 525/329.5; 525/55

(57) ABSTRACT

Disclosed are polyester compositions comprising a polyester polymer, such as poly(lactic acid), and an impact modifier comprising a tubular reactor produced ethylene copolymer derived from monomers (a) ethylene; (b) one or more olefins of the formula CH₂═C(R¹)CO₂R², where R¹ is hydrogen or an alkyl group with 2-8 carbon atoms and R² is an alkyl group with 1-8 carbon atoms, such as methyl, ethyl, or butyl; and (c) one or more olefins of the formula CH₂═C(R³)CO₂R⁴, where R³ is hydrogen or an alkyl group with 1-6 carbon atoms, such as methyl, and R⁴ is glycidyl.

This application claims priority to U.S. provisional application No. 60/947,172, filed Jun. 29, 2007, the entire disclosure of which is incorporated herein by reference.

The invention relates to thermoplastic polyester compositions comprising impact modifiers derived from tubular reactor produced ethylene copolymers.

### BACKGROUND OF THE INVENTION

Polyester polymers have a broad range of industrial and biomedical applications. However, physical limitations such as brittleness and slow crystallization may prevent easy injection molding of polyesters into articles that have an acceptable degree of toughness for many applications. Therefore, numerous impact modifiers have been developed to improve the toughness of the polyesters, and among them are ethylene copolymers. For example, Japanese patent JP9316310 discloses a poly(lactic acid) resin composition comprising a modified olefin compound as an impact modifier and examples of those modified olefin compounds are ethylene-glycidyl methacrylate copolymers grafted with polystyrene, poly(dimethyl methacrylate), etc. and copolymers of ethylene and α-olefins grafted with maleic anhydride and maleimide. US2006-0173133 discloses a toughened poly(hydroxyalkanoic acid) composition wherein an ethylene copolymer (e.g., an ethylene-butyl acrylate-glycidyl methacrylate terpolymer) is used as an impact modifier.

One problem associated with the use of conventional ethylene copolymers as impact modifiers for polyesters is that they tend to introduce haze to the blends. Many applications for polyesters value contact or full optical transparency for the aesthetics necessary for the end-use packaging article, such as cups, trays, or films. To facilitate better quality control, optical transparency is also preferred in semi-finished polyester articles. For example, it is desirable to maintain the clarity of amorphous preformed sheets or injection molded tubes which are subsequently used for thermoforming into trays or bottles. Moreover, some applications value lowered haze in melt strands, as computerized optical sensors can scan for dark specks or other impurities deleterious to downstream processing. Hence, it is desirable to develop an impact modifier which can improve the toughness of the polyester without excessively compromising its clarity.

### SUMMARY OF THE INVENTION

The invention provides a composition comprising, or produced from, polyester and a modifier wherein (i) the polyester is present in the composition from about 60 to about 98 weight %; (ii) the modifier is present in the composition from about 0.5 to about 30 weight % and comprises a tubular reactor-produced ethylene copolymer; (iii) the ethylene copolymer comprises repeat units derived from (a) about 20 to about 95 weight % of ethylene; (b) 0 to about 70 wt % of one or more olefins of the formula CH₂═C(R¹)CO₂R², wherein R¹ is hydrogen or an alkyl group with 1 to 8 carbon atoms and R² is an alkyl group with 1 to 8 carbon atoms; and (c) about 0.5 to about 25 weight % of one or more olefins of the formula CH₂═C(R³)CO₂R⁴, wherein R³ is hydrogen or an alkyl group with 1-6 carbon atoms, and R⁴ is glycidyl; and (iv) the weight % of the polyester and the modifier is based on the total weight of the polyester and the modifier.

The invention further provides an article comprising, or made of, the polyester composition described above.

### DETAILED DESCRIPTION OF THE INVENTION

All references disclosed herein are incorporated by reference.

The invention provides a thermoplastic composition comprising a polyester polymer and an impact modifier comprising a tubular reactor-produced ethylene copolymer.

As used here, the term “copolymer” means polymers containing two or more different monomers. The terms “dipolymer” and “terpolymer” mean polymers containing only two and three different monomers respectively. The phrase “copolymer of various monomers” means a copolymer whose units are derived from the various monomers.

Provided here is a polyester composition comprising a polyester polymer and an impact modifier derived from (or made of) a tubular reactor produced ethylene copolymer. Also provided here is an article derived from (or made of) such a polyester composition.

### Polyester Polymer

Polyester polymers are derived from condensation of diols and diacids (or derivatives thereof). Preferred polyester polymers include, but are not limited to, aromatic polyesters and aliphatic polyesters. Exemplary aromatic polyesters include homopolymers or copolymers of poly(ethylene terephthalate) (PET or 2GT), polyarylate, liquid crystal polyesters that melt below 295° C., poly(trimethylene terephthalate) (PTT or 3GT), poly(ethylene isophthalate), poly(ethylene naphthalate), poly(butylene naphthalate), poly(butylene terephthalate) (PBT or 4GT). Exemplary aliphatic polyesters include homopolymers or copolymers of poly(hydroxyalkanoic acid) (PHA) (e.g., poly(lactic acid), poly(glycolic acid), poly(caprolactone), poly(trimethylene adipate, and poly(trimethylene)succinate).

Preferably, the polyester polymer used here is a poly(hydroxyalkanoic acid) polymer, which can be prepared from the polymerization of hydroxyalkanoic acids having from 2 to 7 (or more) carbon atoms, including polymers derived from the polymerization of 6-hydroxyhexanoic acid, also known as polycaprolactone (PCL), and polymers derived from the polymerization of 3-hydroxyhexanoic acid, 4-hydroxyhexanoic acid, or 3-hydroxyheptanoic acid. The poly(hydroxyalkanoic acids) are preferably derived from the polymerization of hydroxyalkanoic acids having 2 to 5 carbon atoms, e.g., glycolic acid, lactic acid, 3-hydroxypropionate, 2-hydroxy-butyrate, 3-hydroxybutyrate, 4-hydroxybutyrate, 3-hydroxyvalerate, 4-hydroxyvalerate, or 5-hydroxyvalerate.

The terms “poly(hydroxyalkanoic acid)” or “poly(hydroxyalkanoic acid) polymer” refer to any homopolymer or copolymer comprising at least one comonomer derived from a hydroxyalkanoic acid. When a specific poly(hydroxyalkanoic acid) is used, such as poly(glycolic acid), poly(lactic acid) or poly(hydroxybutyrate), it refers to any homopolymer or copolymer comprising at least one comonomer derived from the particular hydroxyalkanoic acid.

Poly(hydroxyalkanoic acid) polymers also include copolymers derived from more than one type of hydroxyalkanoic acids, such as poly(hydroxybutyrate-hydroxyvalerate) copolymer (PHBN) and poly(glycolic acid-lactic acid) copolymer (PGA/LA). Such copolymers can be prepared by catalyzed copolymerization of a polyhydroxyalkanoic acid or derivative with one or more cyclic esters and/or dimeric cyclic esters. Such comonomers include glycolide (1,4-dioxane-2,5-dione); the dimeric cyclic ester of glycolic acid; lactide (3,6-dimethyl-1,4-dioxane-2,5-dione); α,α-dimethyl-β-propiolactone; the cyclic ester of 2,2-dimethyl-3-hydroxy-propanoic acid; β-butyrolactone; the cyclic ester of 3-hydroxybutyric acid; δ-valerolactone; the cyclic ester of 5-hydroxypentanoic acid; ε-caprolactone; the cyclic ester of 6-hydroxyhexanoic acid; and the lactone of its methyl substituted derivatives (such as 2-methyl-6-hydroxyhexanoic acid, 3-methyl-6-hydroxyhexanoic acid, 4-methyl-6-hydroxyhexanoic acid, 3,3,5-trimethyl-6-hydroxyhexanoic acid, etc.); the cyclic ester of 12-hydroxy-dodecanoic acid and 2-p-dioxanone; and the cyclic ester of 2-(2-hydroxyethyl)-glycolic acid.

Poly(hydroxyalkanoic acid) polymers may also include copolymers of one or more hydroxyalkanoic acid monomers or derivatives with other comonomers, including aliphatic and aromatic diacid and diol monomers such as succinic acid, adipic acid, terephthalic acid, ethylene glycol, 1,3-propanediol, and 1,4-butanediol.

Poly(hydroxyalkanoic acid) polymers may also be made by living organisms or isolated from plant matter. Numerous microorganisms have the ability to accumulate intracellular reserves of poly(hydroxyalkanoic acid) polymers. For example, the copolymer of poly(3-hydroxybutyrate-co-3-hydroxyvalerate) (PHB/V) has been produced by fermentation of the bacterium Ralstonia eutropha. Fermentation and recovery processes for other types of poly(hydroxyalkanoic acid) polymers have also been developed using a range of bacteria including Azotobacter, Alcaligenes latus, Comamonas testosterone and genetically engineered E. coli and Klebsiella. U.S. Pat. No. 6,323,010 discloses a number of poly(hydroxyalkanoic acid) polymers prepared from genetically modified organisms.

Some examples of poly(hydroxyalkanoic acids) include poly(glycolic acid) (PGA), poly(lactic acid) (PLA), poly(hydroxybutyrate) (PHB), or combinations of two or more thereof.

Poly(hydroxyalkanoic acid) polymer may be produced by bulk polymerization. A poly(hydroxyalkanoic acid) may be synthesized through the dehydration-polycondensation of the hydroxyalkanoic acid. A poly(hydroxyalkanoic acid) may also be synthesized through the dealcoholization-polycondensation of an alkyl ester of poly(glycolic acid) or by ring-opening polymerization of a cyclic derivative such as the corresponding lactone or cyclic dimeric ester. The bulk polymerization is usually carried out by two production processes, i.e., a continuous process and a batch process. Japanese Patent Laid-Open No. (JP-A) 03-502115 discloses a process wherein bulk polymerization for cyclic esters is carried out in a twin-screw extruder. JP A 07-26001 discloses a process for the polymerization for biodegradable polymers, wherein a bimolecular cyclic ester of hydroxycarboxylic acid and one or more lactones are continuously fed to a continuous reaction apparatus having a static mixer for ring-opening polymerization. JP-A 07-53684 discloses a process for the continuous polymerization for aliphatic polyesters, wherein a cyclic dimer of hydroxycarboxylic acid is fed together with a catalyst to an initial polymerization step, and then continuously fed to a subsequent polymerization step built up of a multiple screw kneader. U.S. Pat. No. 2,668,162 and U.S. Pat. No. 3,297,033 describe batch processes.

Glycolic acid can be derived from sugar cane. Poly(glycolic acid) can be synthesized by the ring-opening polymerization of glycolide and is sometimes referred to as poly-glycolide.

Poly(lactic acids) include poly(lactic acid) homopolymers and copolymers of lactic acid and other monomers containing at least 50 mole % of repeat units derived from lactic acid or its derivatives and mixtures thereof having a number average molecular weight of 3,000 to 1,000,000, 10,000 to 700,000, or 20,000 to 600,000. The poly(lactic acid) may contain at least 70 mole % of repeat units derived from (e.g. made of) lactic acid or its derivatives. The poly(lactic acid) homopolymers and copolymers can be derived from d-lactic acid, l-lactic acid, or a mixture thereof (including a racemic mixture thereof). The copolymer may be a random copolymer or a block copolymer or a stereo block copolymer. A mixture of two or more poly(lactic acid) polymers can also be used in this invention, such as a racemic mixture that may be used to form a stereo complex. Poly(lactic acid) may be prepared by the catalyzed ring-opening polymerization of the dimeric cyclic ester of lactic acid, which is referred to as “lactide” and poly(lactic acid) is also referred to as “polylactide.”

Copolymers of lactic acid can be prepared by catalyzed copolymerization of lactic acid, lactide or another lactic acid derivative with one or more cyclic esters and/or dimeric cyclic esters as described above.

### Impact Modifiers

The impact modifier used here comprises at least one tubular reactor-produced ethylene copolymer.

Ethylene copolymer refers to a polymer derived from (e.g. made of) ethylene and other additional comonomer(s). The ethylene copolymer comprises at least one polymer derived from polymerizing monomers (a) ethylene; (b) one or more olefins of the formula CH₂═C(R¹)CO₂R², where R¹ is hydrogen or an alkyl group with 1-8 carbon atoms and R² is an alkyl group with 1-8 carbon atoms, such as methyl, ethyl, or butyl; and (c) one or more olefins of the formula CH₂═C(R³)CO₂R⁴, where R³ is hydrogen or an alkyl group with 1-6 carbon atoms, such as methyl, and R⁴ is glycidyl. Monomers (b) and can be methyl, ethyl, or butyl methacrylates. One or more of n-butyl acrylate, tert-butyl acrylate, iso-butyl acrylate, and sec-butyl acrylate may be used. Repeat units derived from monomer (a) may comprise about 20 to about 95 weight %, about 20 to about 90 weight %, about 40 to about 90 weight %, or about 50 to about 80 weight % of the total weight of the ethylene copolymer. Repeat units derived from monomer (b) may comprise 0 to about 70 weight %, about 3 to about 70 weight %, about 3 to about 40 weight %, about 15 to about 35 weight %, or about 20 to about 35 weight % of the total weight of the ethylene copolymer. Repeat units derived from monomer (c) may comprise about 0.5 to about 25 weight %, about 2 to about 20 weight %, or about 3 to about 17 weight % of the total weight of the ethylene copolymer. In certain embodiments, monomers (b) may be optional. Specific examples of the ethylene copolymers used herein include terpolymers produced by copolymerization of ethylene, butyl acrylate, and glycidyl methacrylate, which are referred to as EBAGMA, and dipolymers produced by copolymerization of ethylene and glycidyl methacrylate, which are referred to as E/GMA.

Additional monomers, such as carbon monoxide (CO) comonomers, may be included in addition to monomers (a) to (c) in producing the ethylene copolymer described above. When present, repeat units derived from carbon monoxide may comprise up to about 20 weight % or about 3 to about 15 weight % of the total weight of the ethylene copolymer.

Ethylene copolymers can be produced by batch or continuous autoclave or continuous tubular reactors.

The ethylene copolymers used as the impact modifier for polyesters are, however, tubular reactor-produced ethylene copolymers. By “tubular reactor produced ethylene copolymer” it is meant that the copolymer is produced in a continuous tubular reactor under high pressure and elevated temperature. Specifically, in a tubular reactor process, ethylene and the other reactant comonomer(s) are polymerized in a tubular reactor with additional introduction of reactant comonomer(s) along the tube. More specifically, a typical tubular reactor comprise a long (e.g., 1 km or more) reaction tube with series of injection points located along the tube and a portion of each comonomer is added at each of these injection points during the polymerization process. By the intentional introduction of the monomers along the reaction flow path within the tubular reactor the inherent consequences of dissimilar reaction kinetics for the respective ethylene and the other comonomer(s) is alleviated or partially compensated. Without being bound by the following postulation, it is believed that such tubular reactor produced ethylene copolymers have a greater relative degree of heterogeneity because a complex blend of different copolymers are created at each point down the length of the tube. In addition, the tubular reactor produced ethylene copolymers may be different from the conventional autoclave produced ethylene copolymers in comonomer ratios, branch lengths, and etc. Moreover, given the same average comonomer ratios, the tubular reactor produced ethylene copolymers tend to be stiffer and more elastic and have higher melting point than the conventional autoclave produced ethylene copolymers.

Furthermore, at the same average comonomer ratios, the tubular reactor produced ethylene copolymers tend to have lower residual (unreacted) comonomer content than do the conventional autoclave produced ethylene copolymers when the polymerizations are run economically, which means that the unit running is neither excessively slowly or of long duration. For example residual monomer content of butylacrylate may be 10 to 100 times lower in tubular reactor produced ethylene copolymers compared to conventional autoclave produced copolymers. Low levels of residual comonomer are important to the odor aesthetics of impact modifiers and/or to avoid taste effects on food packaging made of polyesters with impact modifiers.

The manufacturing of tubular reactor ethylene copolymers is well known to one skilled in the art, see e.g., U.S. Pat. No. 3,350,372; U.S. Pat. No. 3,756,996; U.S. Pat. No. 5,532,066, and Richard T. Chou, Mimi Y. Keating and Lester J. Hughes, “High Flexibility EMA made from High Pressure Tubular Process”, Annual Technical Conference—Society of Plastics Engineers (2002), 60th (Vol. 2), 1832-1836. Tubular reactor produced ethylene copolymers are commercially available from E. I. du Pont de Nemours and Company, Wilmington, Del. (“DuPont”) with the trademark ELVALOY® AC acrylate copolymer.

The tubular reactor-produced ethylene copolymers used herein are not grafted or otherwise modified post-polymerization.

Theoretically, however, the tubular reactor-produced ethylene copolymers used here can also be produced in a series of continuous autoclave reactors or in a single multizone autoclave provided that each of the individual autoclaves or zones are fed with comonomer at ratios different from each other. Such multizone autoclave reactors are disclosed, e.g., in U.S. Pat. No. 5,543,233; U.S. Pat. No. 5,571,878; and U.S. Pat. No. 5,532,066.

In addition to the tubular reactor produced ethylene copolymer, the impact modifier used here may further incorporate (such as by subsequent melt blending or pellet mixing) one or more copolymers of ethylene and an alkyl acrylate ester such methyl acrylate or ethyl acrylate or butyl acrylate at up to about 50 weight %, or up to about 25 weight %, or about 1 to about 10 weight % based on the total weight of the impact modifier. The impact modifier may yet further comprise copolymers of ethylene and an alkacrylate or an alkyl alkacrylate ester at up to about 50 weight %, or about 5 to about 20 weight %, or about 10 to about 15 weight %, based on the total weight of the impact modifier. The higher the percentages of such additional polymer(s) in the tubular reactor produced ethylene copolymers, higher shear might be required to mix the resulting impact modifier into the polyester to achieve small enough dispersion of the impact modifier for improved haze.

The invention provides a polyester composition comprising at least one polyester polymer, as described above, and at least one impact modifier derived from (or made of) a tubular reactor produced ethylene copolymer, as described above. Preferably, the polyester polymer may be present at a level of about 60 to about 98 weight %, and the tubular reactor produced ethylene copolymer at a level of about 0.5 to about 30 weight %, or about 2 to about 30 weight %, or about 2 to about 20 weight %, or about 5 to about 20 weight %.

The polyester composition disclosed here may further comprise at least one optional cationic catalyst which may promote faster melt dispersion or smaller sized particles of the tubular reactor produced ethylene copolymer impact modifiers into the polyester polymers, especially for those polyesters based on iso- or tere-phthalates. Such catalysts are described in U.S. Pat. No. 4,912,167 and are sources of catalytic cations such as Al³⁺, Fe²⁺, Mn²⁺, Sn²⁺, and Zn²⁺. Suitable catalysts include, but are not limited to, salts of hydrocarbon mono-, di-, or polycarboxylic acids, such as acetic acid and stearic acid. Inorganic salts such as carbonates may also be used. Examples of catalysts include, but are not limited to, stannous octanoate, zinc stearate, zinc carbonate, and zinc diacetate (hydrated or anhydrous). When used, the cationic catalyst may comprise about 0.01 to about 3 parts by weight per hundred parts by weight of the polyester polymer and the impact modifier.

The polyester compositions may further comprise other additives such as 0 to about 5 weight % of plasticizer; 0 to about 5 weight % of antioxidants and stabilizers; 0 to about 40 weight % of fillers; 0 to about 40 weight % of reinforcing agents; 0 to about 10 weight % of nanocomposite reinforcing agents; 0 to about 40 weight % of flame retardants, and/or 0 to about 10 weight % of UV stabilizers. Examples of suitable fillers include glass fibers and minerals such as precipitated CaCO3, talc, and wollastonite. However, to maintain the optical quality of the polyester compositions, it is preferred to include additives or fillers having a small particle size (e.g., below about 200 nanometers, or below 20 nanometers). In addition, it is preferred that the difference of the index of refraction between the additives and substrate polyesters need to be as low as 0.1 or less, or 0.01 or less at the visible wavelengths.

The polyester composition can be prepared by melt blending the polyester polymer and the tubular reactor produced ethylene copolymer derived impact modifier until they are dispersed to a substantial homogeneity to the naked eye and do not delaminate upon injection molding. Other additives may be also uniformly dispersed in the blend. The blend may be obtained by combining the component materials using any melt-mixing method known in the art. For example: 1) the component materials may be mixed to substantial homogeneity using a melt-mixer such as a single or twin-screw extruder, blender, kneader, Banbury mixer, roll mixer, etc., to give a resin composition; or 2) a portion of the component materials can be mixed in a melt-mixer, and the rest of the component materials subsequently added and further melt-mixed until substantially homogeneous.

The invention also provides an article comprising or produced from the polyester composition disclosed here. The composition may be molded into articles using any suitable melt-processing technique. Commonly used melt-molding methods include injection molding, extrusion molding, profile extrusion, or blow molding. The compositions may be formed into films and sheets by extrusion. These sheets, if quenched rapidly enough to be amorphous or essentially free of crystalline polyester, may be further thermoformed into crystallized or amorphous articles and structures. Alternatively, these articles and structures may be oriented in the machine direction to the flow of the polymer and/or the transverse direction either from the melt or at a later stage in the processing of the composition. The compositions may also be used to form fibers and filaments that may be oriented either from the melt or at a later stage in the processing of the composition. For example, in the case for oriented from an amorphous filament, the filament maybe oriented after it is cooled and then heated up again above the glass transition temperature of the polyester. Such orientation may induce crystallization of the polyester or in the case of a highly amorphous copolyester crystallization may not be induced by the orientation process. Examples of articles that may be formed from the polyester compositions include, but are not limited to, knobs, buttons, disposable eating utensils, films, thermoformable sheeting and the like. Amorphous parisons used in blow molding containers may be prepared by injection molding and rapid quenching. Blow molded containers such as bottles, jars and the like may be formed by heating up and expanding a parison in the amorphous form or by expanding a parison in the melted form. Films and sheets can be used to prepare packaging materials and containers such as pouches, lidding, thermoformed containers such as trays, cups, and bowls. Other thermoformed packaging articles include clam shells, handling-trays, point-of-purchase display stands, two-pieces boxes (lid and base combinations), dispenser bodies, bifoldable articles, and the like. The polyester compositions disclosed here may also be stamped into shapes such as in the case for blister packaging or shallow compartments used for pharmaceutical compartments.

### EXAMPLES

The following Examples and Comparative Examples are intended to be illustrative of the present invention, and are not intended in any way to limit the scope of the present invention.

### Tubular Reactor Process

Two samples of ethylene-butyl acrylate-glycidyl methacrylate terpolymers, EBAGMA-1 and EBAGMA-2, were produced by the tubular reactor process. In particular, EBAGMA-1 was produced using two monomer feeds of comonomers butyl acrylate and glycidyl methacrylate and each followed by an initiator injection of ethylene, whereas EBAGMA-2 was produced using the same two monomer feeds and initiator injections followed by a third initiator injection of ethylene at a point further down the tube. In addition, EBAGMA-1 was made under conditions whereby 70% of the comonomers were introduced at the second monomer feed while EBAGMA-2 was made with 53% of the comonomers introduced at the first monomer feed and 47% at the second monomer feed.

### Compounding

The compositions of the examples were prepared by melt compounding the component material in a 30 mm co-rotating Werner & Pfleiderer twin screw extruder. Pellets of polylactic acid and toughener were dry blended and fed into the extruder together. The extruder screw was composed of forward conveying elements with a 5% length of kneading blocks part in the middle length. The screw speed was 200 RPM, throughput was 30 lb/hr (13.6 kb/hr), and tip melt temperature was about 190° C. The melt exited through an 8 inch (20.3 cm) wide sheeting die with a die gap of about 26 mils (0.66 mm). The melt curtain fell about 5 cm onto a quench drum set to about 22° C. The resulting sheet was amorphous polylactic acid containing the toughener as established by use of Differential Scanning Calorimetry.

### Batch Mixing and Subsequent Processing

Batch blending was accomplished on a Haake Rheocord 9000 batch mixer with a 55 g mixing chamber at a temperature of 210° C. and a rotor speed of 50 rpm. Pellets were charged at once into the preheated chamber containing rotating rotors, the lid was applied, and the mixture allowed to mix and warm toward the goal temperature for 1 minute. The mixing was completed after an additional 2 minutes and after which the melt was discharged into a cool pan.

Once the mixture was cooled, a 1 g sample was hand-sheared from the total and sized to about 0.5 cm particles. The sample was placed as a pile not higher than 0.5 cm and with particles touching each other on an aluminum sheet inside a stainless steel template or mold (0.25 mm thick and having a 5.1×5.1 cm square opening). Another aluminum sheet was placed on the top of the pile and the resulting sandwich was then positioned on the base of a press that was preheated to 190° C. Immediately thereafter, the top platen (also preheated to 190° C.) was positioned to kiss the aluminum sheet for 1 minute. The press' platens were brought together in about 5 seconds to a total pressure of about 2000 psi which represents the platens being tight against the stainless steel mold. The pressure was retained for 1 minute and released within 5 seconds. The sandwich was immediately placed in another press cooled to about 22° C. (ambient) and held under pressure until cooled to ambient. The sandwich was then disassembled to provide a 0.25 mm thick, 5.1 cm×5.1 cm sample of polymer blend.

### Materials

PLA2002D used in the following examples was a poly(lactic acid) polymer with the trade name of NatureWorks® 2002D from NatureWorks LLC, Minnetonka, Minn.

EBAGMA-A used in the following examples was an autoclave produced ethylene/n-butyl acrylate/glycidyl methacrylate terpolymer containing repeat units derived from 66.75 weight % of ethylene, 28 weight % of n-butyl acrylate, and 5.25 weight % of glycidyl methacrylate. The resin has a Melt Index of 12 dg/minute at 190° C. and a melting endotherm of about 25 J/g occurring over the range of 50° C. to 80° C.

EBAGMA-1 and EBAGMA-2 were two samples of ethylene/n-butyl acrylate/glycidyl methacrylate terpolymers produced by the continuous tubular reactor process described above. EBAGMA-1 contained repeat units derived from 67.8 weight % of ethylene, 27.3 weight % of n-butyl acrylate, and 4.9 weight % of glycidyl methacrylate. Its Melt Index was 14.8 dg/minute and its melting endotherm of was about 10 J/g occurring over the range of 85° C. to 105° C. EBAGMA-2 contained repeat units derived from 67.3 weight % of ethylene, 27.5 weight % of n-butyl acrylate, and 5.2 weight % of glycidyl methacrylate. Its Melt Index was 10 dg/minute and its melting endotherm of was about 7 J/g occurring over the range of 80° C. to 100° C.

### Examples E1-E4 and Comparative Examples CE1-CE3

In examples E1-E4 and comparative examples CE1-CE3, 22-25 mil (0.56-0.64 mm) thick sheets were produced through the compounding process described above. Compositions and various properties of these sheets were tabulated in Table 1.

Toughness of the sample sheets (amorphous unless otherwise noted) were determined by pliers tests, scissors tests, nail tests, Elmendorf Tear, MIT Flexural fatigue, and tensile elongation at break. Clarity of the samples sheets were measured by the internal haze method.

In the pliers test, an 1 inch wide strip was dead-bended back on itself using pliers over about a 0.1 second period of time. If the strip broke, then it was recorded as not passing. The crease for this test was in the transverse direction (TD). In the scissors test, the top ½ inch of lab scissors was used to cut the sheet perpendicularly within 0.1 second. After fully closing the scissors, if the end of the cut propagated a crack, it was then recorded as not passing. The direction of the scissors cut was in the TD. In the nail test, a 7D nail was hammered within 0.1 second through a 1 inch wide sheet (and within 0.64 cm of its edge) that is backed by a smooth wood backing. If the sheet fractured into pieces, it was then recorded as not passing. The internal haze was determined on amorphous sheets using ASTMD1003. The internal haze was accomplished by application of an oil coating to the surfaces of the sheet to eliminate surface scratches from generating haze. The Elmendorf Tear was determined using ASTM Method 1922 at ambient conditions using Pendulum 6400. The tear was determined for sheeting in both the Transverse and Machine Direction. MIT Flexural fatigue for amorphous sheeting was conducted on a Folding Endurance Tester machine (Tinius Olsen, Willow Grove, Pa.) using a 500 gm weight, a #10 spring, 1350 folding angle, 15 mm wide strip, and referencing ASTM Method D2176-97a. The average flex cycles to failure was reported from 5 repeat tests. Tensile properties were determined by stamping out a dog bone shape (2.54 cm stretch length and 4.8 mm width) from the sheet with the center axis of the dog-bone in the middle of the sheet. The test rate was conducted at a speed of 2.54 cm per minute.

The data demonstrate that tubular reactor-produced EBAGMA improves the toughness of the poly(lactic acid) as well as conventional autoclave produced EBAGMA. However, the sheets made of poly(lactic acid) compositions comprising tubular reactor-produced EBAGMA (E1-E4) had better clarity over those sheets made of poly(lactic acid) compositions comprising conventional autoclave produced EBAGMA (C2 and C3), when the EBAGMA were present at the same level in the compositions.

TABLE 1

| | CE1 | CE2 | E1 | E2 | E3 | E4 | CE3 |
|---|---|---|---|---|---|---|---|
| PLA2002D (lb) | 4.00 | 4.00 | 4.00 | 4.00 | 4.00 | 4.00 | 4.00 |
| EBAGMA-A (lb) | | 0.08 | | | | | 0.21 |
| EBAGMA-1 (lb) | | | 0.08 | | | 0.21 | |
| EBAGMA-2 (lb) | | | | 0.08 | 0.21 | | |
| Wt % of EBAGMA in the composition | | 1.96 | 1.96 | 1.96 | 4.99 | 4.99 | 4.99 |
| Toughness | | | | | | | |
| Pliers Test (% passing) | 0 | 0 | 33 | 33 | 100 | 66 | 100 |
| Scissors Test (% passing) | 0 | 33 | 22 | 55 | 88 | 99 | 88 |
| Nail Test (% passing) | 0 | 33 | 0 | 33 | 100 | 100 | 100 |
| Elmendorf Tear in TD (g/mil) | 23 | 33 | 31 | 24 | 44 | 42 | 39 |
| Elmendorf Tear in MD (g/mil) | 18 | 25 | 26 | 36 | 36 | 39 | 39 |
| MIT Flexural Fatigue (cycles) | 34 | 160 | 100 | 200 | 1900 | 1800 | 3000 |
| Tensile Properties Amorphous | | | | | | | |
| Elongation at Break (av %) | 220 | 210 | 236 | 180 | 230 | 240 | 230 |
| Secant Modulus (~2%) (kpsi) | 400 | 370 | 360 | 355 | 335 | 365 | 365 |
| Tensile Properties Crystallized | | | | | | | |
| Elongation at Break (av %) | 17 | 21 | 40 | 22 | 70 | 21 | 110 |
| Secant Modulus (~2%) (kpsi) | 375 | 375 | 380 | 370 | 365 | 350 | 363 |
| Internal Haze (%) | 2 | 39 | 10 | 17 | 52 | 43 | 74 |

### Examples E5 and E6 and Comparative Example CE4

In examples E5 and E6 and comparative example CE4, 10 mil thick sample sheets were made by the batch mixing process described above. Compositions and internal haze of these sheets were tabulated in Table 2.

Here again, it is demonstrated that sheets made of poly(lactic acid) compositions comprising tubular reactor-produced EBAGMA (E5 and E6) had improved clarity over sheets made of poly(lactic acid) compositions comprising conventional autoclave-produced EBAGMA (CE4).

TABLE 2

| | CE4 | E5 | E6 |
|---|---|---|---|
| PLA2002D (g) | 53.1 | 53.1 | 53.1 |
| EBAGMA-A (g) | 1.9 | | |
| EBAGMA-1 (g) | | 1.9 | |
| EBAGMA-2 (g) | | | 1.9 |
| Percent of EBAGMA (%) | 3.5 | 3.5 | 3.5 |
| Haze (%) | 31.7 | 10.7 | 15.8 |

1. A composition comprising, or produced from, polyester and a modifier wherein
the polyester is present in the composition from about 60 to about 98 weight %;
the modifier is present in the composition from about 0.5 to about 30 weight % and comprises (1) a tubular reactor-produced ethylene copolymer, (2) an ethylene copolymer produced in a series of autoclaves or a multizone autoclave in which the monomer feed compositions are different in each autoclave or zone in such a way to increase the compositional heterogeneity, or combination of (1) and (2);
the ethylene copolymer comprises repeat units derived from (a) about 20 to about 95 weight % of ethylene; (b) 0 to about 70 wt % of one or more olefins of the formula CH₂═C(R¹)CO₂R², wherein R¹ is hydrogen or an alkyl group with 1 to 8 carbon atoms and R² is an alkyl group with 1 to 8 carbon atoms; and (c) about 0.5 to about 25 weight % of one or more olefins of the formula CH₂═C(R³)CO₂R⁴, wherein R³ is hydrogen or an alkyl group with 1-6 carbon atoms, and R⁴ is glycidyl; and
the weight % of the polyester and the modifier is based on the total weight of the polyester and the modifier.

2. The composition of claim 1 wherein the polyester polymer comprises aromatic polyester.

3. The composition of claim 2 wherein the polyester is selected from the group consisting of poly(ethylene terephthalate), poly(trimethylene terephthalate), poly(butylene terephthalate), and combinations of two or more thereof.

4. The composition of claim 1 wherein the polyester polymer comprises polycarbonate.

5. The composition of claim 1 wherein the polyester polymer comprises aliphatic polyester.

6. The composition of claim 5 wherein the aliphatic polyester is a poly(hydroxyalkanoic acid).

7. The composition of claim 6 wherein the poly(hydroxy-alkanoic acid) comprises repeat units derived from 6-hydroxyhexanoic acid, 3-hydroxyhexanoic acid, 4-hydroxyhexanoic acid, 3-hydroxyheptanoic acid, or combinations of two or more thereof.

8. The composition of claim 6 wherein the poly(hydroxy-alkanoic acid) comprises repeat units derived from glycolic acid, lactic acid, 3-hydroxypropionic acid, 2-hydroxy-butyric acid, 3-hydroxybutyric acid, 4-hydroxybutyric acid, 3-hydroxy-valeric acid, 4-hydroxyvaleric acid, 5-hydroxyvaleric acid, or combinations of two or more thereof.

9. The composition of claim 8 wherein the poly(hydroxy-alkanoic acid) is poly(glycolic acid), poly(lactic acid), poly(hydroxy-butyric acid), poly(hydroxybutyrate-hydroxyvalerate) copolymer, copolymer of glycolic acid and lactic acid, or combinations of two or more thereof.

10. The composition of claim 9 wherein the poly(hydroxyalkanoic acid) is poly(lactic acid).

11. The composition in claim 10 wherein the poly(lactic acid) is a stereo complex of poly(D-lactic acid) and poly(L-lactic acid).

12. The composition of claim 1 wherein the ethylene copolymer is an ethylene-glycidyl methacrylate copolymer, ethylene-butyl acrylate-glycidyl methacrylate terpolymer, or combinations thereof.

13. The composition of claim 11, wherein the ethylene copolymer is an ethylene-glycidyl methacrylate copolymer, ethylene-butyl acrylate-glycidyl methacrylate terpolymer, or combinations thereof.

14. The composition of claim 12 wherein the ethylene copolymer is derived from about 40 to about 90 weight % of ethylene, about 3 to about 70 weight % of CH₂═C(R¹)CO₂R², and about 3 to about 17 weight % of CH₂═C(R³)CO₂R⁴.

15. The composition of claim 13 wherein the ethylene copolymer is derived from about 50 to about 80 weight % of ethylene, about 20 to about 35 weight % of CH₂═C(R¹)CO₂R², and about 3 to about 17 weight % of CH₂═C(R³)CO₂R⁴.

16. An article comprising or produced from a composition wherein the article is film or sheet, molded article, extruded article, thermoformed article, oriented article, or combination of two or more thereof and the composition is as recited in claim 1.

17. The article of claim 16, wherein the composition is the poly(hydroxyalkanoic acid) is poly(lactic acid) including a stereo complex of poly(D-lactic acid) and poly(L-lactic acid).

18. The article of claim 16 wherein the wherein the ethylene copolymer is an ethylene-glycidyl methacrylate copolymer, ethylene-butyl acrylate-glycidyl methacrylate terpolymer, or combinations thereof.

19. The article of claim 17 wherein the ethylene copolymer is derived from about 50 to about 80 weight % of ethylene, about 20 to about 35 weight % of CH₂═C(R¹)CO₂R², and about 3 to about 17 weight % of CH₂═C(R³)CO₂R⁴.

20. The article of claim 19 wherein the article is a film or sheet.
